(19) United States
(12) Patent Application Publication
(10) Pub. No.: US 2023/0068591 A1
(43) Pub. Date: Mar. 2, 2023

(54) METHOD FOR MAKING METALLOGENIC SERIES MAP OF MINERAL DEPOSIT

(71) Applicant: Qinghai Geological Survey Institute, Xining (CN)

(72) Inventors: Tong PAN, Xining (CN); Tao WANG, Xining (CN); Bingzhang Wang, Xining (CN); Pingqian Yi, Xining (CN); Yongwen Wang, Xining (CN); Yulong Li, Xining (CN); Jiqing Li, Xining (CN); Jie Han, Xining (CN); Yongge Tian, Xining (CN)

(21) Appl. No.: 17/411,530

(22) Filed: Aug. 25, 2021

(51) Int. Cl. G01V 99/00

(52) U.S. Cl. CPC G01V 99/005; G01V 2210/72

(57) ABSTRACT

A method for making a metallogenic series map of mineral deposits is disclosed. The method includes making a list of mineral varieties and mineral producing areas, determining typical mineral deposits, making a geotectonic map, determining a mineral deposit model by combining the typical mineral deposits and metallogenic geotectonic background conditions, compiling a synthem-stratum-magma-mineralization histogram, obtaining regional metallogenetic regularities, selecting a geographic layer as a base map, and making the metallogenic series map of mineral deposits on the basis of the base map according to the regional metallogenetic regularities. The metallogenic series map of mineral deposits of the present disclosure is a regional metallogenetic map which not only reflects the mineral variety, scale, type and epoch of mineral deposits in different geotectonic environments but also reflects the relationship between mineral deposits and mineral deposit combinations to form a “five-in-one” legend.

### TECHNICAL FIELD

The present disclosure relates to the technical field of geological mapping, and more particularly relates to a method for making a metallogenic series map of mineral deposits.

### BACKGROUND

A metallogenetic map is a geological map that predicts distribution rules and possible lodging positions of mineral deposits in a certain region according to the known mineral occurrence and mineral deposit data in combination with geological background analysis based on a certain metallogenic theory. The metallogenetic map reflects the position of mineralization in geological history and the relationship between mineral deposits and other geological factors, which can clarify time-space distribution rules of mineral deposits and metallogenic geotectonic environments. The metallogenetic map shows both the existing mineral deposits and the mined-out mineral deposits, and shows the relationship between them and the geological environments through analogy and the places where known elements are concentrated for mineralization by the geologic process, to predict the places where no mineral deposits are found.

However, the existing method for making a metallogenetic map often adopts a new metallogenic theory, which leads to the limitation of an application range thereof; moreover, on the existing metallogenetic map, only the “three-in-one” mineral geological map legend of mineral variety, mineral deposit type and scale is reflected, while the metallogenic epoch and metallogenic series are not reflected, so the expression is single and not systematic, and the results lack of integrity.

Therefore, the problem to be urgently solved by those skilled in the art is to provide a method for making a metallogenic series map to overcome the defects existing in the existing metallogenetic map.

### SUMMARY

In view of this, the present disclosure provides a method for making a metallogenic series map of mineral deposits. The metallogenic series map of mineral deposits is a regional metallogenetic map which not only reflects the mineral variety, scale, type and epoch of mineral deposits in different geotectonic environments but also reflects the relationship between mineral deposits and mineral deposit combinations to form a “five-in-one” legend, being favorable for exploring mineral deposits which may exist but are not discovered according to the ideas of “full mineralization” and “vacant prospecting”.

To achieve the above purpose, the present disclosure adopts the following technical solution:

A method for making a metallogenic series map of mineral deposits, comprising the following steps:

(1) collecting information about a mineral producing area, outputting a list of mineral varieties and mineral producing areas after integrating the information; determining typical mineral deposits according to the list of mineral varieties and mineral producing areas;

(2) making a geotectonic map, determining metallogenic geotectonic background conditions;

(3) determining a mineral deposit model in combination with the typical mineral deposit and the metallogenic geotectonic background conditions;

(4) dividing metallogenic units according to the mineral deposit model, compiling a synthem-stratum-magma-mineralization histogram, obtaining regional metallogenetic regularities;

(5) selecting a geographic layer as a base map, marking mineral variety of mineral deposits, genetic type, scale, metallogenic epoch, relationship between mineral deposits and mineral deposit combinations, ore-bearing stratum and metallogenic geological environment on the base map by means of different patterns, symbols, codes, lines and annotations according to the regional metallogenetic regularities, and then making the metallogenic series map of mineral deposits.

The preferred technical solution has the advantageous effects that according to the present disclosure, typical mineral deposits are determined through data collection; a geotectonic map is made, mineralogenetic geotectonic background conditions are determined; a mineral deposit model is determined according to the typical mineral deposits and the metallogenic geotectonic background conditions; metallogenic units are divided according to the mineral deposit model, a synthem-stratum-magma-mineralization histogram is compiled, regional metallogenetic regularities are obtained; a geographic layer is used as a base map, the metallogenic series map of mineral deposits is made according to the difference in the regional metallogenetic regularities. Moreover, the overall making method is simple in operation, to display various geological elements and mineral contents in line with the principle that the content is substantial, well-structured, moderate in simplicity and complexity, scientific and reasonable; on the made metallogenic series map of mineral deposits, mineral variety of mineral deposits, genetic type, scale, metallogenic epoch, metallogenic series of mineral deposits and metallogenic geological environment are emphatically represented, and the relationship between mineral deposits and mineral deposit combinations is reflected.

Preferably, the mineral production area comprises mineral deposits and mineral occurrences.

Preferably, in step (1), the information about a mineral producing area includes the name, mineral variety, geographic position, area, mineral type, mineral resource reserve scale and grade, main mineral features, metallogenic epoch, metallogenic zone, tectonic unit, exploration degree and development status of the mineral producing area.

Further preferably, the mineral resource reserve scale and grade comprise the mineral resource reserve scale and grade of main mineral varieties, paragenetic mineral varieties and associated mineral varieties; the main mineral features comprise mineral composition, ore type, ore texture and structure, ore body scale, shape and occurrence, ore body combination, wall rock alteration and metallogenic environment; the metallogenic epoch is a superimposed metallogenic epoch.

The preferred technical solution has the advantageous effects that the information content of the mineral production area is clarified, the data base unified, and a basis for determining typical mineral deposits is provided.

Preferably, the principle according to which the typical mineral deposits are determined is as follows: the typical mineral deposits are representative and typical in the aspects of geological positions where the mineral deposits lodge, formed geological conditions and mineral-controlling factors, metallogenic features and prospecting marks; and the typical mineral deposits are high in exploration and research degree, more and complete in various test data, larger in scale and significant in typicality.

Further preferably, 1-2 mineral deposits are selected as typical mineral deposits for each mineral variety, and 1-2 mineral deposits are added as typical mineral deposits for dominant mineral varieties or characteristic mineral varieties.

The preferred technical solution has the advantageous effects that the deterministic principle and number requirements of the typical mineral deposits are determined, and a data basis for determining metallogenic geological background is provided.

Preferably, in step (2), making a geotectonic map specifically includes: using a histogram form as a stratum legend, and combining with tectonic subregions, to reflect a sedimentary geological environment of each period; on the basis of a geological map, simplifying archeozoic and palaeoproterozoic strata to group and group complex, merging mesoproterozoic and neoproterozoic strata to group, merging paleozoic, mesozoic and cenozoic strata to series, highlighting crystalline basement and distribution features, combining crystalline basement expressions with stratigraphic subregions, to reflect geotectonic environments; compiling a magmatic rock lithology-chronological sequence table to reflect the lithology, rock-forming age, and features of rock mass development in each period and relationship with mineralization; labeling the mineral variety, scale and genetic type in the mineral production area.

The preferred technical solution has the advantageous effects that the making process of the geotectonic map is determined, the technical requirements are unified, and the content of the made geotectonic map is standardized and rationalized.

Preferably, the magmatic rock lithology-chronological sequence table is expressed in the form of mesh grid, color and/or pattern according to 8 rock classes and 20 rock types in different geological time periods.

The preferred technical solution has the advantageous effect that the present disclosure adopts the expression form of mesh grid, color and/or pattern so that readers can read from the table the development features of various rock masses in different geological periods, which not only reflects the lithology and rock-forming age, but also reflects the development features of rock masses in different periods and relationship with mineralization.

Preferably, in step (3), the mineral deposit model is an expression form of a common mineral deposit type in a tectonic unit or a metallogenic unit.

The preferred technical solution has the advantageous effects that according to the present disclosure, research on regional metallogenetic regularities is conveniently performed through the mineral deposit model, which is favorable for summarizing metallogenic series.

Preferably, in step (4), dividing metallogenic units includes: numbering and naming level-III and level-IV metallogenic units, typical mineral deposits and boundary faults between every two metallogenic units on the geotectonic map so as to make a metallogenic unit division map;

combining synthem, tectonic unit, stratum and magma with mineralization, directly expressing the geotectonic evolution rules, magmatic evolution features and mineralization in the form of a histogram, making a synthem-stratum-magma-mineralization histogram.

The preferred technical solution has the advantageous effect that according to the present disclosure, the regional metallogenetic regularities can be clearly and legibly expressed through the synthem-stratum-magma-mineralization histogram.

Preferably, in step (5), an administrative boundary layer of the geographic map contains three levels, i.e. provinces, municipalities and counties; a place name annotation layer of the geographic map contains provinces, municipalities, counties and key towns; a river system and lake layer contains lakes, and rivers above order IV and reservoirs; a traffic layer of the geographic map contains high-speed railways, railways, expressways, national roads and county roads.

Further preferably, important mountains on the geographic map are influential mountains marked according to local chronicle text; an out-of-region layer of the geographic map only contains three orders of river systems and national roads; the coordinate parameter measuring scale of the geographic map is 1:500,000.

The preferred technical solution has the advantageous effect that the layer requirements, and layer content and measuring scale of the geographic map are clearly defined.

It can be known from the technical solution that compared with the prior art, the method for making a metallogenic series map of mineral deposits provided by the present disclosure has the following advantages:

(1) the making method disclosed by the present disclosure is simple in operation, to display various geological elements and mineral contents in line with the overall principle that the content is substantial, well-structured, moderate in simplicity and complexity, scientific and reasonable;

(2) the made metallogenic series map of mineral deposits not only reflects the mineral variety, scale, type and epoch of mineral deposits in different geotectonic environments but also reflects the relationship between mineral deposits and mineral deposit combinations to form a “five-in-one” legend, being favorable for exploring mineral deposits which may exist but are not discovered according to the ideas of “full mineralization” and “vacant prospecting”, having actual application value.

### DESCRIPTION OF DRAWINGS

The patent or application file contains at least one drawing executed in color. Copies of this patent or patent application publication with color drawing (s) will be provided by the office upon request and payment of the necessary fee.

To more clearly describe the technical solution in the embodiments of the present disclosure or in the prior art, the drawings required to be used in the description of the embodiments or the prior art will be simply presented below. Apparently, the drawings in the following description are merely the embodiments of the present disclosure, and for those ordinary skilled in the art, other drawings can also be obtained according to the provided drawings without contributing creative labor.

FIG. 1 is a structural schematic diagram of Qinghai province provided by embodiment 2 of the present disclosure.

FIG. 2 is a local enlarged view of an upper part of a mineral legend in FIG. 1;

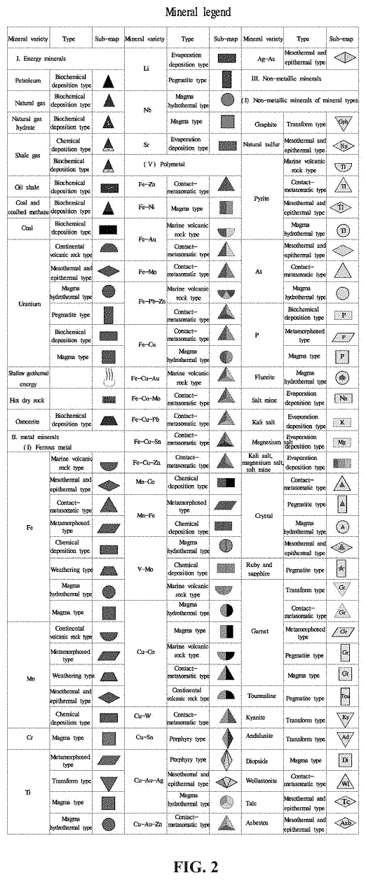

FIG. 3 is a local enlarged view of a middle part of a mineral legend in FIG. 1;

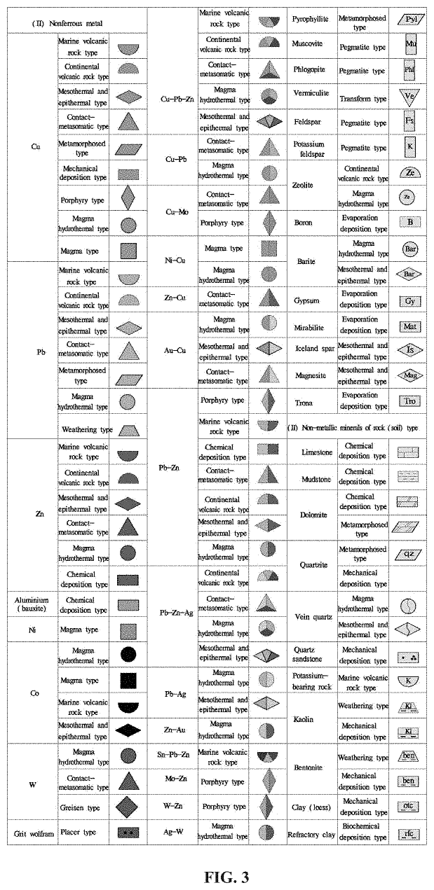

FIG. 4 is a local enlarged view of a lower part of a mineral legend in FIG. 1;

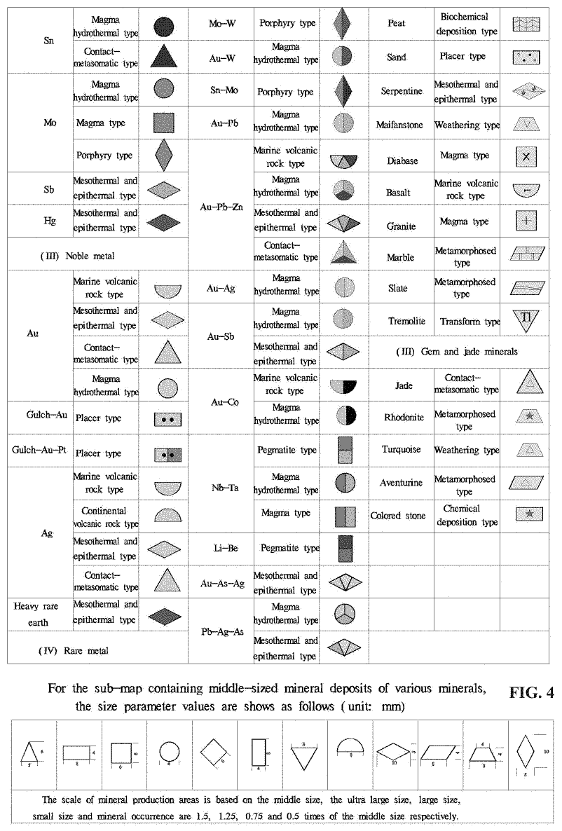

FIG. 5 is a local enlarged view of a part of a top right corner legend in FIG. 1;

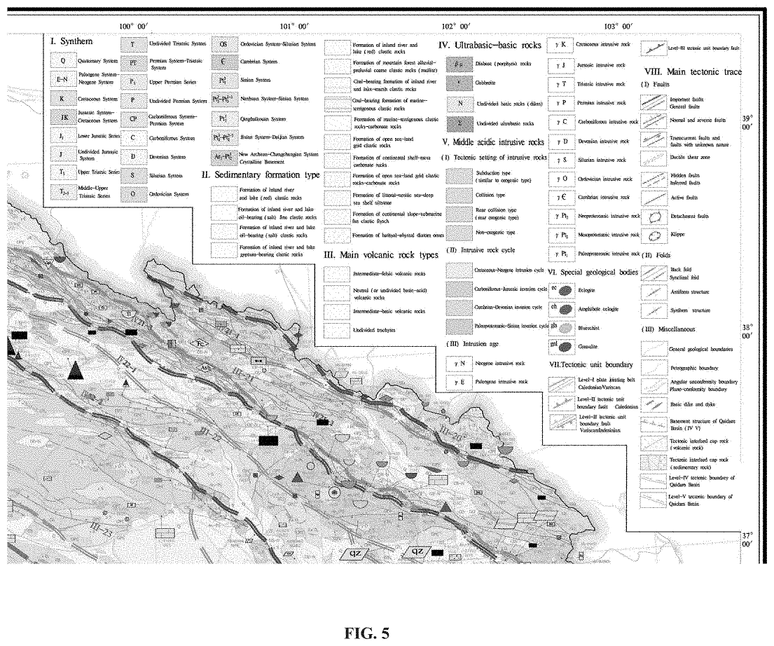

FIG. 6 is a local enlarged view of an upper half of Qinghai tectonic evolution, i.e. mineral deposit structure diagram in FIG. 1;

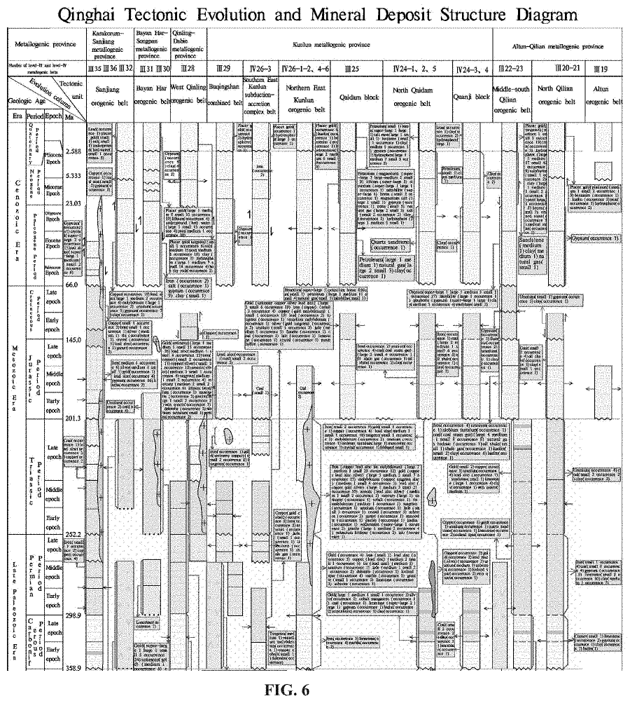

FIG. 7 is a local enlarged view of a lower half of Qinghai tectonic evolution, i.e. mineral deposit structure diagram in FIG. 1;

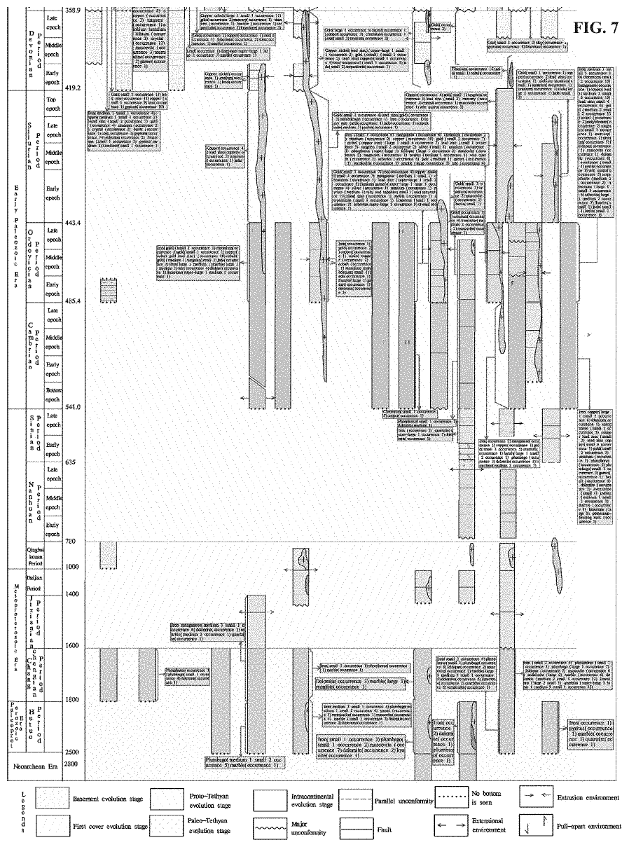

FIG. 8 is a local enlarged view of a metallogenic lineage diagram of mineral deposits in Qinling-Qilian metallogenic domain in FIG. 1;

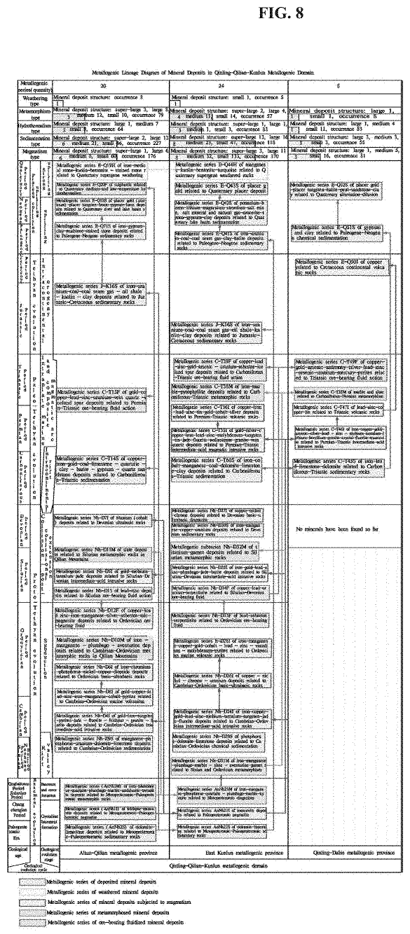

FIG. 9 is a local enlarged view of a metallogenic lineage diagram of mineral deposits in Tethyan metallogenic domain in FIG. 1;

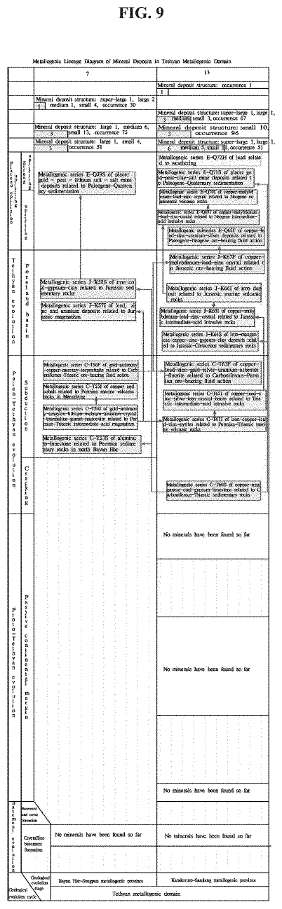

FIG. 10 is a local enlarged view of a histogram showing type structures and mineralogenetic intensity distribution of mineral deposits of Qinghai province in FIG. 1;

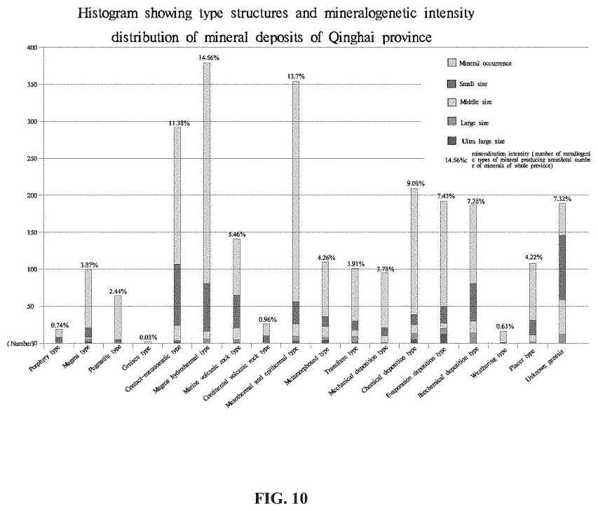

FIG. 11 is a local enlarged view of diagram showing scale-metallogenic intensity and mineralization rate distribution of mineral deposits of level-III metallogenic belts of Qinghai province;

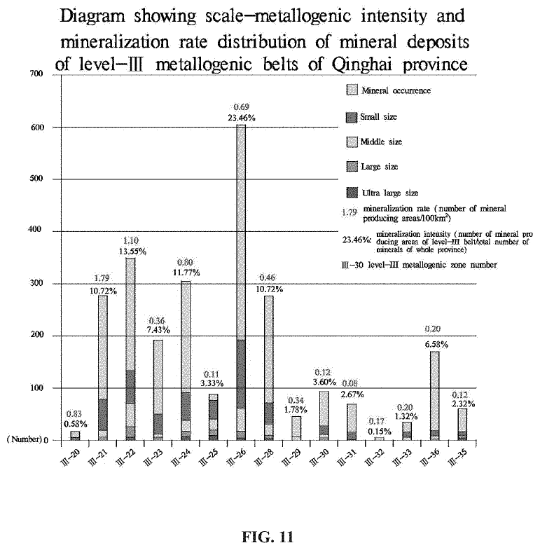

FIG. 12 is a local enlarged view of a diagram showing time distribution-scale and mineralization intensity distribution of mineral deposits of Qinghai province in FIG. 1;

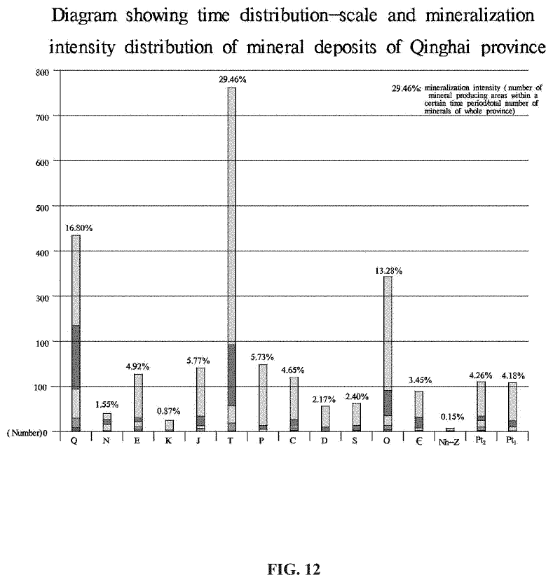

FIG. 13 is a local enlarged view of a part of a geographic legend in FIG. 1;

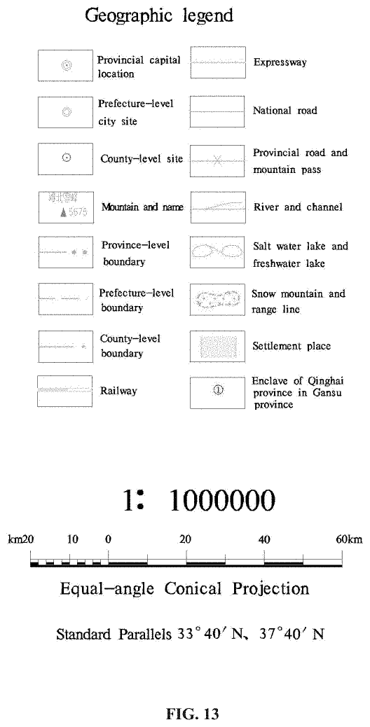

FIG. 14 is a local enlarged view of a table of division results of metallogenic belts of Qinghai province in FIG. 1;

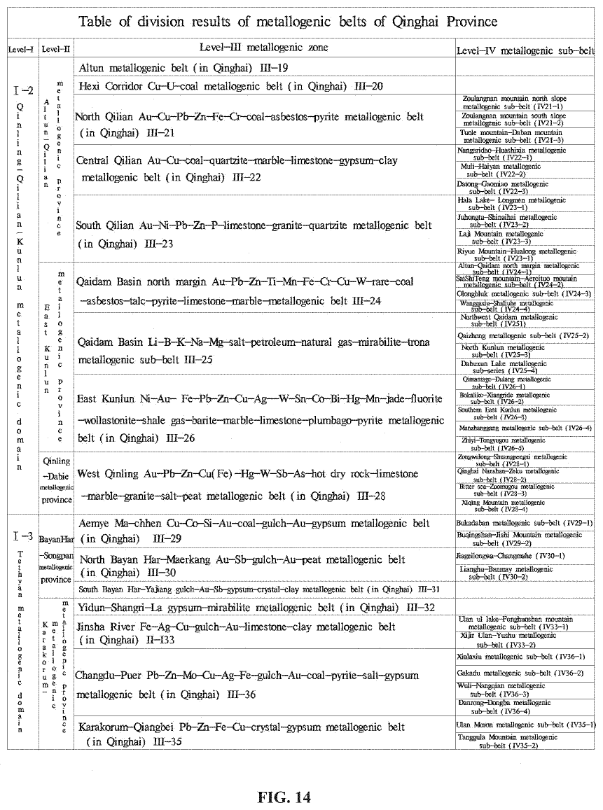

FIG. 15 is a local enlarged view of a part of a diagram showing distribution of level-III and level-IV metallogenic belts of Qinghai province and retrieval subregions of mineral production areas in FIG. 1;

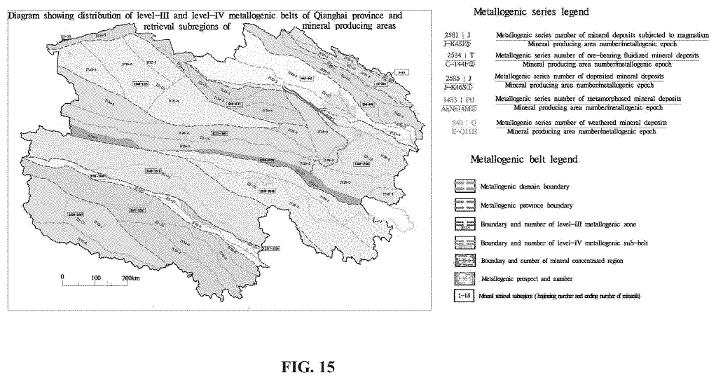

FIG. 16 is a local enlarged view of a part of a schematic diagram showing geotectonic evolution and mineralization of Qinghai province in FIG. 1.

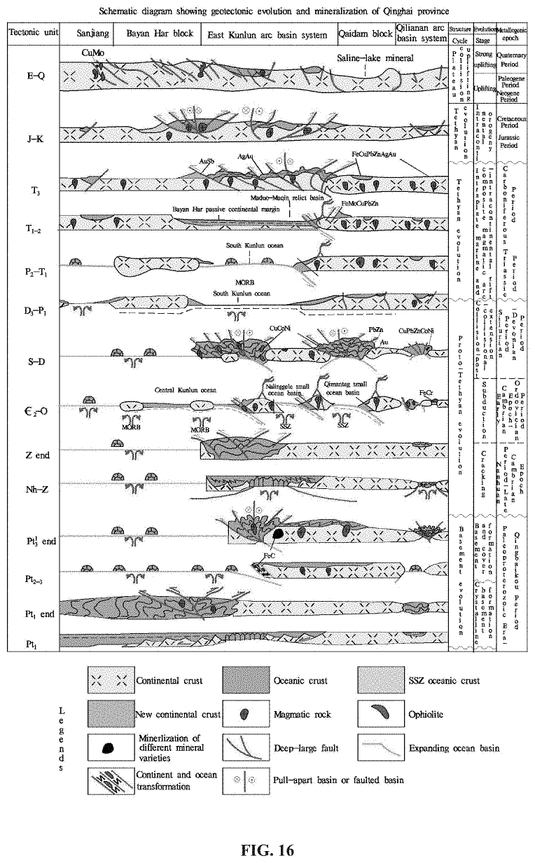

### DETAILED DESCRIPTION

The technical solution in embodiments of the present disclosure will be clearly and fully described below. Apparently, the described embodiments are merely part of the embodiments of the present disclosure, not all of the embodiments. Based on the embodiments in the present disclosure, all other embodiments obtained by those ordinary skilled in the art without contributing creative labor will belong to the protection scope of the present disclosure.

### Embodiment 1

Embodiment 1 of the present disclosure discloses a method for making a metallogenic series map of mineral deposits, specifically comprising the following steps:

(1) collecting information about a mineral producing area, including the name, mineral variety, geographic position, area, mineral type, mineral resource reserve scale and grade, main mineral features, metallogenic epoch, metallogenic zone, tectonic unit, exploration degree and development status of the mineral producing area, and outputting a table of mineral varieties and mineral producing areas after integrating the information;

wherein the mineral resource reserve scale and grade comprise the mineral resource reserve scale and grade of main mineral varieties, paragenetic mineral varieties and associated mineral varieties; the main mineral features comprise mineral composition, ore type, ore texture and structure, ore body scale, shape and occurrence, ore body combination, wall rock alteration and metallogenic environment; the metallogenic epoch is a superimposed metallogenic epoch; the mineral production area includes mineral deposits and mineral occurrences;

according to the table of mineral varieties and mineral producing areas, based on the principle that “1-2 mineral deposits are selected as typical mineral deposits for each mineral variety, and 1-2 mineral deposits are added as typical mineral deposits for dominant mineral varieties or characteristic mineral varieties”, determining typical mineral deposits, wherein it is required that the typical mineral deposits are representative and typical in the aspects of geological positions where the mineral deposits lodge, formed geological conditions and mineral-controlling factors, metallogenic features and prospecting marks; and the typical mineral deposits are high in exploration and research degree, more and complete in various test data, larger in scale and significant in typicality;

(2) making a geotectonic map, and determining metallogenic geotectonic background conditions: using a histogram form as a stratum legend, and combining with tectonic subregions, to reflect a sedimentary geological environment of each period; on the basis of a geological map, simplifying archeozoic and palaeoproterozoic strata to group and group complex, merging mesoproterozoic and neoproterozoic strata to group, merging paleozoic, mesozoic and cenozoic strata to series, highlighting crystalline basement and distribution features, combining crystalline basement expressions with stratigraphic subregions, to reflect geotectonic environments; compiling a magmatic rock lithology-chronological sequence table to reflect the lithology, rock-forming age, and features of rock mass development in each period and relationship with mineralization; labeling the mineral variety, scale and genetic type in the mineral production area;

wherein the magmatic rock lithology-chronological sequence table is expressed in the form of mesh grid, color and pattern according to 8 rock classes and 20 rock types in different geological time periods.

(3) determining a mineral deposit model in combination with the typical mineral deposits and the metallogenic geotectonic background conditions, wherein the mineral deposit model is an expression form of a common mineral deposit type in a tectonic unit or a metallogenic unit;

(4) dividing metallogenic units according to the mineral deposit model, compiling a synthem-stratum-magma-mineralization histogram, obtaining regional metallogenetic regularities;

wherein dividing metallogenic units includes: numbering and naming level-III and level-IV metallogenic units, typical mineral deposits and boundary faults between every two metallogenic units so as to obtain a metallogenic unit division map;

wherein the synthem-stratum-magma-minerlization histogram is to combine synthem, tectonic unit, stratum and magma with mineralization, to directly express geotectonic evolution rules, magmatic evolution features and mineralization in the form of a histogram.

(5) selecting a geographic layer as a base map, marking mineral variety of mineral deposits, genetic type, scale, metallogenic epoch, relationship between mineral deposits and mineral deposit combinations, ore-bearing stratum and metallogenic geological environment on the base map by means of different patterns, symbols, codes, lines and annotations according to the regional metallogenetic regularities, and then making the metallogenic series map of mineral deposits;

wherein an administrative boundary layer of the geographic map contains three levels, i.e. provinces, municipalities and counties; a place name annotation layer contains provinces, municipalities, counties and key towns; a river system and lake layer contains lakes, and rivers above order IV and reservoirs; a traffic layer contains high-speed railways, railways, expressways, national roads and county roads; important mountains are influential mountains marked according to local chronicle text; an out-of-region layer only contains three orders of river systems and national roads; the coordinate parameter measuring scale is 1:500,000.

### Embodiment 2

By taking Qinghai province as an example, embodiment 2 of the present disclosure provides a method for making a metallogenic series map of mineral deposits, specifically comprising the following steps:

(1) collecting information about a mineral producing area, including the name, mineral variety, geographic position, area, mineral type, mineral resource reserve scale and grade, main mineral features, metallogenic epoch, metallogenic zone, tectonic unit, exploration degree and development status of the mineral producing area, and outputting a table of mineral varieties and mineral producing areas after integrating the information;

wherein the mineral resource reserve scale and grade comprise the mineral resource reserve scale and grade of main mineral varieties, paragenetic mineral varieties and associated mineral varieties; the main mineral features comprise mineral composition, ore type, ore texture and structure, ore body scale, shape and occurrence, ore body combination, wall rock alteration and metallogenic environment; the metallogenic epoch is a superimposed metallogenic epoch; the mineral production area includes mineral deposits and mineral occurrences;

according to the table of mineral varieties and mineral producing areas, based on the principles that “1-2 mineral deposits are selected as typical mineral deposits for each mineral variety, and 1-2 mineral deposits are added as typical mineral deposits for dominant mineral varieties or characteristic mineral varieties”, determining typical mineral deposits, wherein it is required that the typical mineral deposits are representative and typical in the aspects of geological positions where the mineral deposits lodge, formed geological conditions and mineral-controlling factors, metallogenic features and prospecting marks; and the typical mineral deposits are high in exploration and research degree, more and complete in various test data, larger in scale and significant in typicality;

(2) making a geotectonic map, and determining metallogenic geotectonic background conditions: using a histogram form as a stratum legend, and combining with tectonic subregions, to reflect a sedimentary geological environment of each period; on the basis of a geological map, simplifying archeozoic and palaeoproterozoic strata to group and group complex, merging mesoproterozoic and neoproterozoic strata to group, merging paleozoic, mesozoic and cenozoic strata to series, highlighting crystalline basement and distribution features, combining crystalline basement expressions with stratigraphic subregions, to reflect geotectonic environments; compiling a magmatic rock lithology-chronological sequence table to reflect the lithology, rock-forming age, and features of rock mass development in each period and relationship with mineralization; labeling the mineral variety, scale and genetic type in the mineral production area;

wherein the magmatic rock lithology-chronological sequence table is expressed in the form of mesh grid, color and pattern according to 8 rock classes and 20 rock types in different geological time periods;

(3) determining a mineral deposit model in combination with the typical mineral deposits and the metallogenic geotectonic background conditions, wherein the mineral deposit model is an expression form of a common mineral deposit type in a tectonic unit or a metallogenic unit;

(4) dividing metallogenic units according to the mineral deposit model, compiling a synthem-stratum-magma-mineralization histogram, obtaining regional metallogenetic regularities;

wherein dividing metallogenic units includes: numbering and naming level-III and level-IV metallogenic units, typical mineral deposits and boundary faults between every two metallogenic units so as to obtain a metallogenic unit division map;

wherein the synthem-stratum-magma-minerlization histogram is to combine synthem, tectonic unit, stratum and magma with mineralization, to directly express geotectonic evolution rules, magmatic evolution features and mineralization in the form of a histogram;

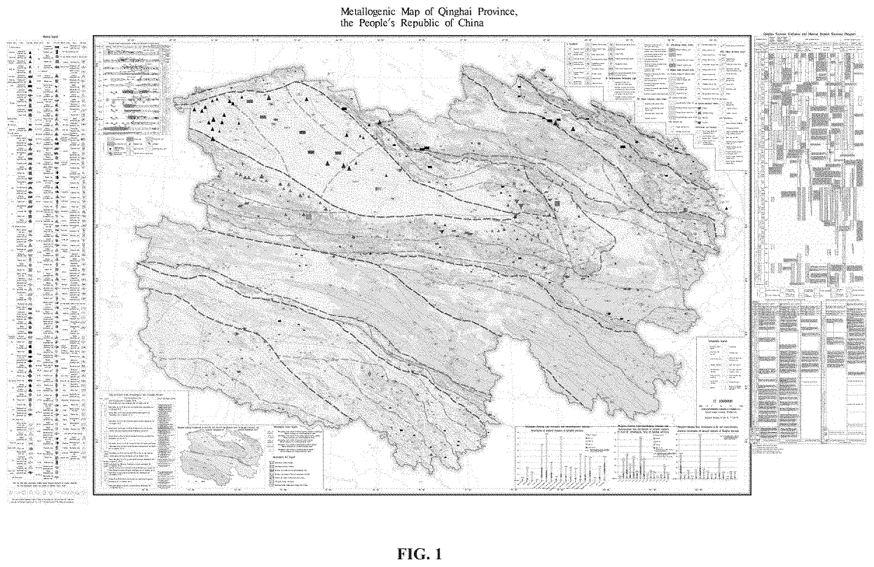

(5) selecting a geographic layer as a base map, marking mineral variety of mineral deposits, genetic type, scale, metallogenic epoch, relationship between mineral deposits and mineral deposit combinations, ore-bearing stratum and metallogenic geological environment on the base map by means of different patterns, symbols, codes, lines and annotations according to the regional metallogenetic regularities, and then making the metallogenic series map of mineral deposits, as shown in FIG. 1;

wherein an administrative boundary layer of the geographic map contains three levels, i.e. provinces, municipalities and counties; a place name annotation layer contains provinces, municipalities, counties and key towns; a river system and lake layer contains lakes, and rivers above order IV and reservoirs; a traffic layer contains high-speed railways, railways, expressways, national roads and county roads; important mountains are influential mountains marked according to local chronicle text; an out-of-region only contains three orders of river systems and national roads; the coordinate parameter measuring scale is 1:500,000.

Each embodiment in the description is described in a progressive way. The difference of each embodiment from each other is the focus of explanation. The same and similar parts among all of the embodiments can be referred to each other. For a device disclosed by the embodiments, because the device corresponds to a method disclosed by the embodiments, the device is simply described. Refer to the description of the method part for the related part.

The above description of the disclosed embodiments enables those skilled in the art to realize or use the present disclosure. Many modifications to these embodiments will be apparent to those skilled in the art. The general principle defined herein can be realized in other embodiments without departing from the spirit or scope of the present disclosure. Therefore, the present disclosure will not be limited to these embodiments shown herein, but will conform to the widest scope consistent with the principle and novel features disclosed herein.

1. A method for making a metallogenic series map of mineral deposits, comprising the following steps:
(1) collecting information about a mineral producing area, outputting a list of mineral varieties and mineral producing areas after integrating the information; determining typical mineral deposits according to the list of mineral varieties and mineral producing areas;
(2) making a geotectonic map, determining metallogenic geotectonic background conditions;
(3) determining a mineral deposit model according to the typical mineral deposits and the metallogenic geotectonic background conditions;
(4) dividing metallogenic units according to the mineral deposit model, compiling a synthem-stratum-magma-mineralization histogram, obtaining regional metallogenetic regularities;
(5) selecting a geographic layer as a base map, marking mineral variety of mineral deposits, genetic type, scale, metallogenic epoch, relationship between mineral deposits and mineral deposit combinations, ore-bearing stratum and metallogenic geological environment on the base map by means of different patterns, symbols, codes according to the regional metallogenetic regularities, lines and annotations, and then making the metallogenic series map of mineral deposits.

2. The method for making a metallogenic series map of mineral deposits according to claim 1, wherein the mineral producing area comprises mineral deposits and mineral occurrences.

3. The method for making a metallogenic series map of mineral deposits according to claim 2, wherein in step (1), the information about a mineral producing area includes the name, mineral variety, geographic position, area, mineral type, mineral resource reserve scale and grade, main features of minerals, metallogenic epoch, metallogenic zone, tectonic unit, exploration degree and development status of the mineral producing area.

4. The method for making a metallogenic series map of mineral deposits according to claim 2, wherein in step (1), the principle according to which the typical mineral deposits are determined is as follows: 1-2 mineral deposits are selected as typical mineral deposits for each mineral variety, and 1-2 mineral deposits are added as typical mineral deposits for dominant mineral varieties or characteristic mineral varieties.

5. The method for making a metallogenic series map of mineral deposits according to claim 2, wherein in step (2), making a geotectonic map specifically includes: using a histogram form as a stratum legend, and combining with tectonic subregions, to reflect a sedimentary geological environment of each period; on the basis of a geological map, simplifying archeozoic and palaeoproterozoic strata to group and group complex, merging mesoproterozoic and neoproterozoic strata to group, merging paleozoic, mesozoic and cenozoic strata to series, highlighting crystalline basement and distribution features, combining crystalline basement expressions with stratigraphic subregions, to reflect geotectonic environments; compiling a magmatic rock lithology-chronological sequence table to reflect the lithology, rock-forming age, and features of rock mass development in each period and relationship with mineralization; labeling the mineral variety, scale and genetic type in the mineral production area.

6. The method for making a metallogenic series map of mineral deposits according to claim 5, wherein the magmatic rock lithology-chronological sequence table is expressed in the form of mesh grid, color and pattern according to 8 rock classes and 20 rock types in different geological time periods.

7. The method for making a metallogenic series map of mineral deposits according to claim 2, wherein in step (3), the mineral deposit model is an expression form of a common mineral deposit type in a tectonic unit or a metallogenic unit.

8. The method for making a metallogenic series map of mineral deposits according to claim 1, wherein in step (4), dividing metallogenic units includes: numbering and naming level-III and level-IV metallogenic units, typical mineral deposits and boundary faults between every two metallogenic units on the geotectonic map so as to make a metallogenic unit division map;
combining synthem, tectonic unit, stratum and magma with mineralization, directly expressing geotectonic evolution rules, magmatic evolution features and mineralization in the form of a histogram, making a synthem-stratum-magma-mineralization histogram.

9. The method for making a metallogenic series map of mineral deposits according to claim 1, wherein in step (5), an administrative boundary layer of the geographic map contains three levels, i.e. provinces, municipalities and counties; a place name annotation layer of the geographic map contains provinces, municipalities, counties and key towns; a river system and lake layer contains lakes, and rivers above order IV and reservoirs; a traffic layer of the geographic map contains high-speed railways, railways, expressways, national roads and county roads.
